(19) United States
(12) Patent Application Publication
(10) Pub. No.: US 2026/0024518 A1
(43) Pub. Date: Jan. 22, 2026

(54) NOISE REDUCTION METHOD, NOISE REDUCTION DEVICE AND ELECTRONIC DEVICE

(71) Applicants: Futaijing Precision Electronics (Yantai) Co., Ltd., Yantai (CN); HON HAI PRECISION INDUSTRY CO., LTD., New Taipei (TW)

(72) Inventor: YU-SYUAN LYU, New Taipei (TW)

(21) Appl. No.: 18/821,795

(22) Filed: Aug. 30, 2024

(30) Foreign Application Priority Data
Jul. 19, 2024 (CN) 202410976121.3

(51) Int. Cl. G10K 11/178; G06V 40/16

(52) U.S. Cl. CPC G10K 11/17823; G06V 40/171; G06V 40/175; G10K 11/17873; G10K 2210/111; G10K 2210/30231; G10K 2210/3027

(57) ABSTRACT

A noise reduction method includes: obtaining environment data of a location where the noise reduction device is placed, the environment data including environment sound and facial images of a population within a preset range of the location; analyzing the facial images of the population to determine whether the one or more persons of the population are in a negative mood; determining whether noise is present in the environment sound when the one or more persons of the population are determined in the negative mood; processing the noise to obtain a noise signal and noise orientations when the noise is present in the environment sound; generating a noise reduction signal having an amplitude same as the noise signal and an opposite phase to the noise signal; and playing the noise reduction signal towards the noise orientation. A noise reduction device and an electronic device are also provided.

### FIELD

The subject matter herein generally relates to the field of noise reduction.

### BACKGROUND

Noise refers to a type of sound that causes people to be upset or is harmful to human health due to large decibel values. With a development of economy, people's living standards are improving, more and more people are constantly improving their environmental requirements, and the noise has been caught people's attention. For example, sound of cars on the street, sound of machines on the construction site, and sound of the decoration drill are the noise. If the noise is not reduced in time, the noise will seriously affect people's life and work.

### BRIEF DESCRIPTION OF THE DRAWINGS

Implementations of the present disclosure will now be described, by way of embodiments, with reference to the attached figures.

FIG. 1 is a diagram illustrating a noise reduction device receiving the sound and transmitting the sound according to the present disclosure.

FIG. 2 is a diagram illustrating a process of the noise reduction according to the present disclosure.

FIG. 3 is a structure diagram illustrating a plurality of a noise reduction equipment according to the present disclosure.

FIG. 4 is another structure diagram illustrating a plurality of the noise reduction equipment according to the present disclosure.

FIG. 5 is another structure diagram illustrating a plurality of the noise reduction equipment according to the present disclosure.

FIG. 6 is a structure diagram illustrating the noise reduction device according to the present disclosure.

FIG. 7 is a flowchart illustrating a noise reduction method according to the present disclosure.

FIG. 8 is a structure diagram illustrating an electronic device according to the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The connection can be such that the objects are permanently connected or releasably connected. The term “comprising,” when utilized, means “including, but not necessarily limited to,” it specifically indicates open-ended inclusion or membership in the so-described combination, group, series, and the like.

The sound of cars on the street, the sound of machines on the construction site, and the sound of the decoration drill are noise. If the noise is not reduced, the noise will seriously affect people's life and work.

At prior art, some methods reduce noise source by means of warning signs, installing sound insulation device, government legislation and so on. But the methods need to pay additional living costs or effect of the noise reduction is low. Therefore, a noise reduction device is disclosed.

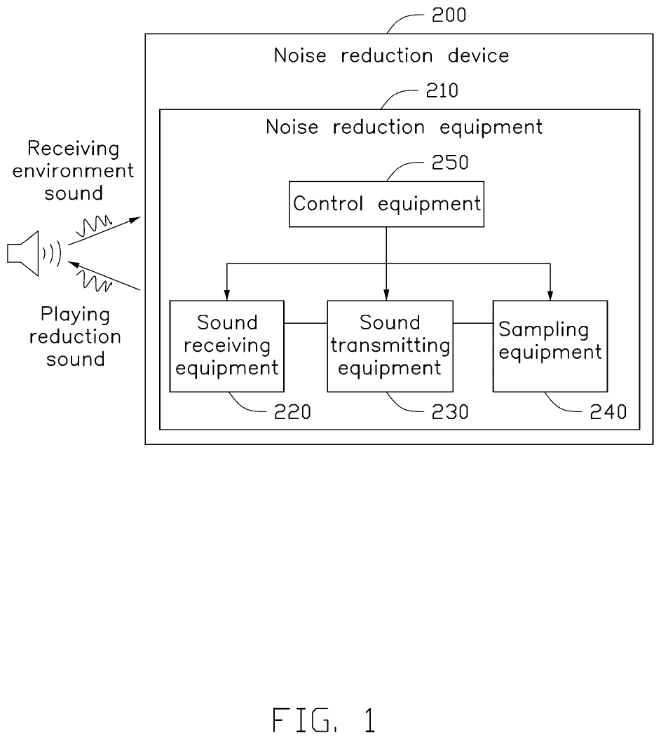

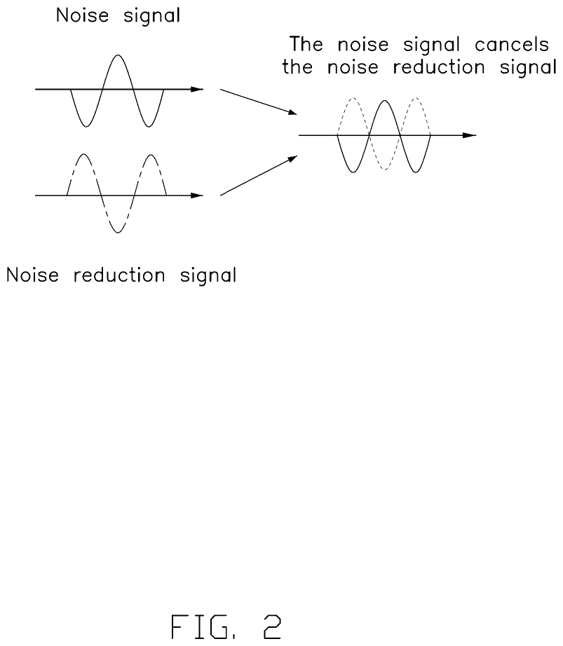

Please refer to FIG. 1 and FIG. 2, the noise reduction device 200 includes one or more noise reduction equipments 210. The one or more noise reduction equipments 210 include a sound receiving equipment 220, a sound transmitting equipment 230, a sampling equipment 240 and a control equipment 250. The control equipment 250 communicates with the sound receiving equipment 220, the sound transmitting equipment 230, and the sampling equipment 240.

The sound receiving equipment 220 is configured to receive environment sound of a location where the noise reduction device 210 is placed, the sound receiving equipment 220 receives the sound produced by the one or more sound sources. The sampling equipment 240 is configured to capture facial images of a population within a preset range of the location. The control equipment 250 is configured to analyze the facial images of the population to determine whether one or more persons of the population are in a negative mood. When the one or more persons of the population are determined to be in the negative mood using an image processing algorithm, the control equipment 250 is configured to determine whether noise is present in the environment sound. When the noise is determined to be in the environment sound, the control equipment 250 is configured to process data of the noise to obtain a noise signal and noise orientations and generate a noise reduction signal having an amplitude same as the noise signal, and an opposite phase to the noise signal. The sound transmitting equipment 230 is configured to play the noise reduction signal towards the noise orientations. As shown in FIG. 2, the noise signal cancels the noise reduction signal, so that the noise can be reduced. The image processing algorithm is the prior art.

In one embodiment, the sound receiving equipment 220 is a microphone, the microphone receives the environment sound of the location where the noise reduction device 210 is placed. The sampling equipment 240 is a camera, the camera captures the facial images of the population within the preset range of the location. The control equipment 250 is a control chip, the control chip determines the facial images of the population and the environment sound and generates the noise reduction signal according to determination result. The sound transmitting equipment 230 is a loudspeaker, the loudspeaker plays the noise reduction signal towards the noise orientations. Therefore, the noise is reduced and cannot affect people's life and work.

In one embodiment, when the sound receiving equipment 220 is the microphone, the microphone can be used to obtain the environment sound more accurately. For example, the microphone can be an omnidirectional microphone or a gun-type directional microphone. The preset range can be a circular area with a radius of 5 m, a circular area with a radius of 10 m, or a square area with a length of 5 m and a width of 8 m. The preset range can be set according to actual situation, and the preset range can also be an irregular area.

In some embodiments, the noise reduction device 200 includes the one or more noise reduction equipments 210. When the noise reduction device 200 includes the one noise reduction equipment 210. The one noise reduction equipment 210 includes the one sound receiving equipment 220, the one sound transmitting equipment 230, the one sampling equipment 240, and the one control equipment 250. The one control equipment 250 communicates with the one sound receiving equipment 220, the one sound transmitting equipment 230, and the one sampling equipment 240. The plurality of noise reduction devices 200 can be installed in one area or in multiple areas.

In one embodiment, when the noise reduction device 200 includes the plurality of noise reduction equipments 210. Each of the plurality of noise reduction equipments 210 includes the sound receiving equipment 220, the sound transmitting equipment 230, the sampling equipment 240 and the control equipment 250. The plurality of noise reduction devices 200 can be installed in multiple areas. The plurality of noise reduction devices 200 communicates with each other by the plurality of control equipments 250.

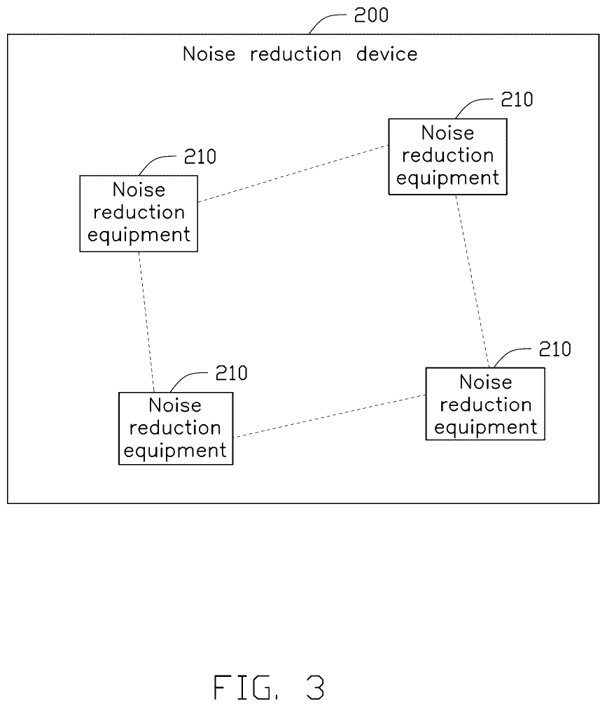

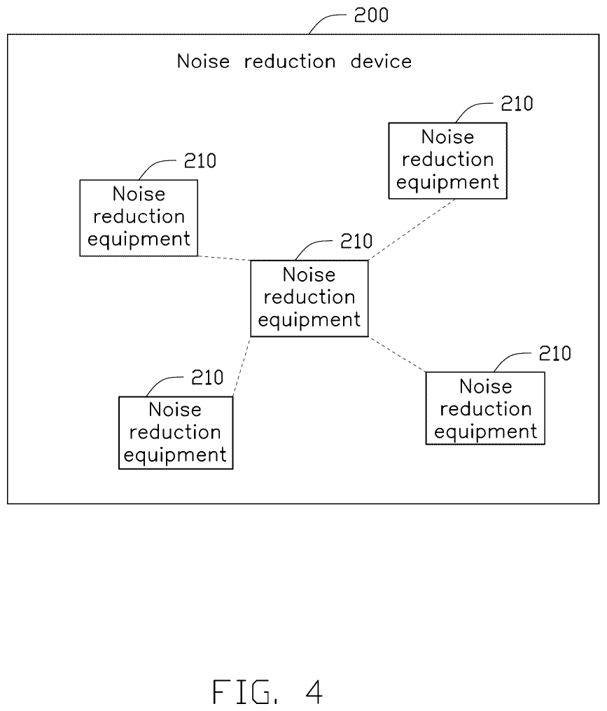

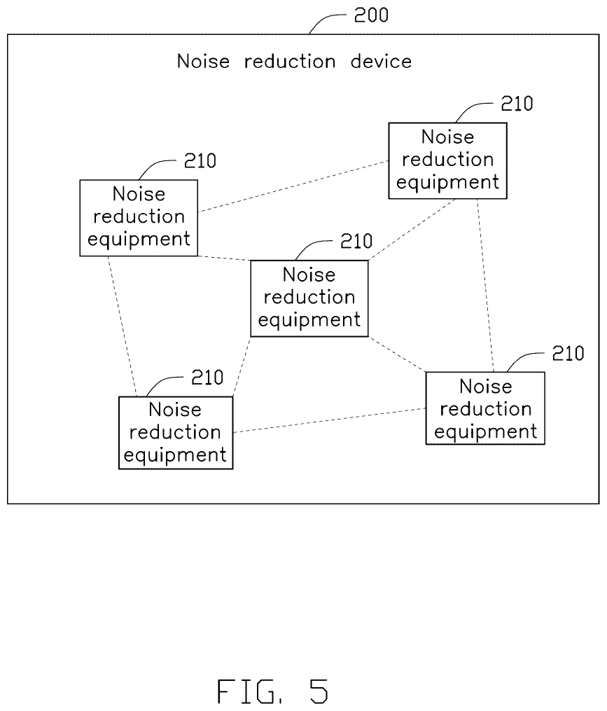

Please refer to FIG. 3, the plurality of noise reduction devices 200 is connected in a ring. Please refer to FIG. 4, the one noise reduction device 200 is in a center, and the other noise reduction devices 200 are connected to the noise reduction device 200 at the center. Please refer to FIG. 5, a network connection is provided between the plurality of noise reduction equipments 210.

The plurality of noise reduction equipments 210 in one area can simultaneously receive the environment sound, when the sound source is one, each of the plurality of noise reduction equipments 210 determines whether the noise is present in the environment sound and processes the data of the noise to obtain the noise signal and the noise orientations. Since the plurality of noise reduction equipments 210 is at different locations and receives the different sound orientations. The plurality of noise reduction equipments 210 generates multiple different noise orientations. Each of the plurality of noise reduction equipments 210 generates the noise reduction signal having the amplitude same as the noise signal, and the opposite phase to the noise signal. The noise reduction signal is played towards the noise orientations by the sound transmitting equipment 230 in each of the plurality of noise reduction devices 200.

The plurality of noise reduction equipments 210 in one area can simultaneously reduce the noise from one sound source, or the plurality of noise reduction equipments 210 can separately reduce the noise from multiple sound sources in one area. Efficiency of the noise reduction is improved.

The plurality of noise reduction equipments 210 is installed in multiple areas. Each of the plurality of noise reduction equipments 210 can reduce the noise in one area of the noise reduction equipments 210.

In some embodiments, the sound reduction device 200 can be a charging device. The charging devices not only have a charging function, but also have a noise reduction function. With continuous development of new energy technology, the charging devices are installed various areas. For example, the charging devices are installed in shopping malls, roadside, schools, communities and so on. The charging devices with the noise reduction function can reduce the noise frequently occurring in daily life without adding additional devices and considering installation locations and installation area of additional devices. The cost of the noise reduction is low.

In other embodiments, the sound reduction device 200 can be installed in an air conditioner to reduce the noise generated by the air conditioner. The sound reduction device 200 can also be installed in a cooling device of workshop or directedly installed in the workshop to reduce the noise in the workshop. The sound reduction device 200 can avoid the noise in the workshop for a long time to affect the hearing of workers.

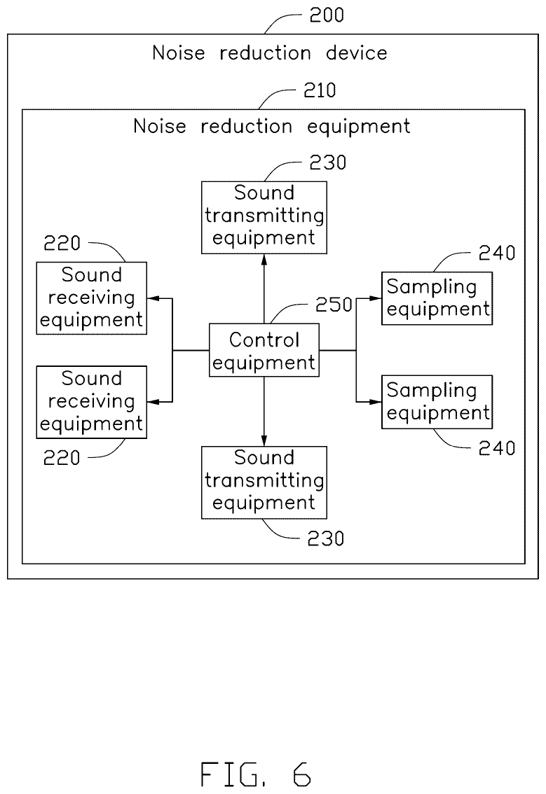

As shown in FIG. 6, one exemplary embodiment of the noise reduction device 200, the noise reduction device 200 includes the one noise reduction equipment 210. The one noise reduction equipment 210 includes the plurality of sound receiving equipments 220, the plurality of sound transmitting equipments 230 and the plurality of sampling equipments 240 and the one control equipment 250. One of the plurality of sound receiving equipments 220 matches with one of the plurality of sound transmitting equipments 230 and one of the plurality of sampling equipments 240. The one control equipment 250 communicates with the plurality of sound receiving equipments 220, the plurality of sound transmitting equipments 230, and the plurality of sampling equipments 240. The number of the sound receiving equipment 220 is the same with the number of the sound transmitting equipment 230 and the number of the sampling equipment 240.

Each of the plurality of sound receiving equipments 220 is configured to receive the environment sound of a location where the sound receiving equipment 220 is placed. Each of the plurality of sampling equipments 240 is configured to capture the facial images of the population within the preset range of the location, each of the plurality of sound transmitting equipments 230 is configured to play the noise reduction signal towards the noise orientations.

In one embodiment, the one sound receiving equipment 220, the one sound transmitting equipment 230 and the one sampling equipment 240 are marked as a receiving and acquiring device. According to actual needs, the receiving and acquiring device can be installed in different positions.

In one embodiment, when the sound source is one, the plurality of receiving and acquiring devices can collect the noise generated by the one sound source. Since the plurality of sound receiving equipments 220 in the plurality of receiving and acquiring devices is at different locations, positions, and orientations between each of the plurality of sound receiving equipments 220 and the sound source are also different.

The one control equipment 250 processes the environment sound received by the plurality of sound receiving equipments 220 to obtain the sound time when the environment sound reaches each of the plurality of sound receiving equipments 220. The one control equipment 250 calculates the sound time to obtain the distance and the noise orientations between each of the plurality of sound transmitting equipments 230 and the sound source. The one control equipment 250 controls the plurality of sound transmitting equipments 230 to play the noise reduction signal, according to the distance and the noise orientations between each of the plurality of sound transmitting equipments 230 and the sound source.

When it is not convenient to install the plurality of noise reduction equipments 210 in one area, the plurality of receiving and acquiring devices can be installed in different locations within the area. The plurality of sound receiving equipments 220 at different locations receives the environment sound, after the one control equipment 250 analyzes the environment sound and the facial images of the population collected by the sampling equipments 240, the plurality of sound transmitting equipments 230 plays the noise reduction signal towards the one or more noise sources. The efficiency of noise reduction is improved and the installation cost of noise reduction equipment 210 is reduced.

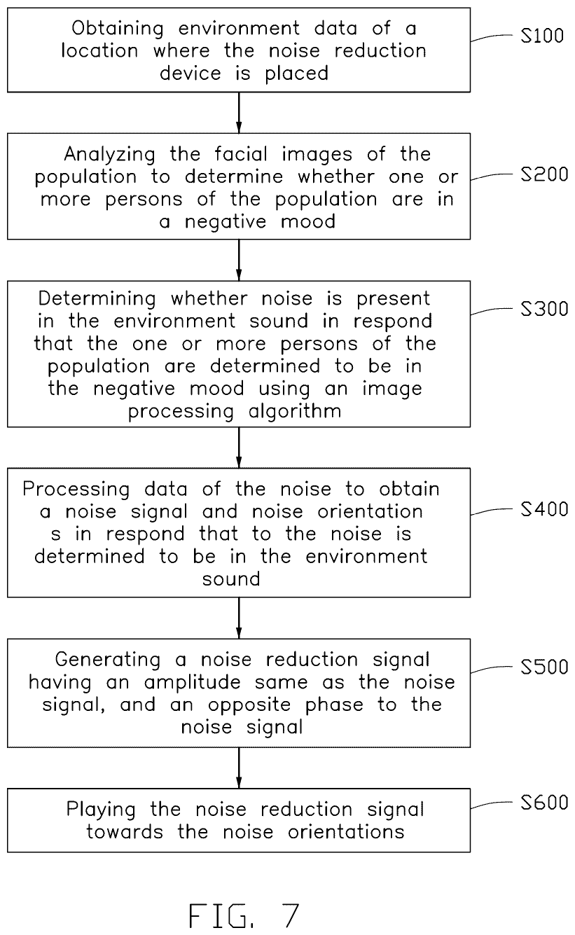

FIG. 7 illustrates one exemplary embodiment of a noise reduction method. The noise reduction method is applied to the noise reduction device 200. The flowchart presents an exemplary embodiment of the method. The exemplary method is provided by way of example, as there are a variety of ways to carry out the method. Each block shown in FIG. 7 may represent one or more processes, methods, or subroutines, carried out in the example method. Furthermore, the illustrated order of blocks is illustrative only and the order of the blocks can change. Additional blocks can be added, or fewer blocks may be utilized, without departing from this disclosure.

In block S100, the environment data of the location of the noise reduction device is obtained, the environment data includes the environment sound and the facial images of the population within the preset range of the location.

In one embodiment, the noise reduction device 200 includes the noise reduction equipment 210. The noise reduction equipment 210 includes the sound receiving equipment 220, the sound transmitting equipment 230, the sampling equipment 240 and the control equipment 250. The control equipment 250 communicates with the sound receiving equipment 220, the sound transmitting equipment 230 and the sampling equipment 240.

In one embodiment, the sound receiving equipment 220 receives the environment sound of the location where the sound receiving equipment 220 is placed. The sampling equipment 240 captures the facial images of the population within the preset range of the location.

In block S200, the facial images of the population are analyzed to determine whether one or more persons of the population are in the negative mood.

In one embodiment, the control equipment 250 extracts the facial feature information from the facial images of the population and analyzes facial expression of the facial feature information, the facial expression includes a negative emotional expression and a positive emotional expression. The control equipment 250 determines whether the facial expression is the negative emotional expression or the positive emotional expression.

In one embodiment, the negative emotional expression is the expression of fear, disgust, pain and so on. The positive emotional expression is the expression of happiness and calm and so on.

In block S300, when the one or more persons of the population are determined in the negative emotional expression using the image processing algorithm, the noise is determined whether the noise is present in the environment sound.

In block S400, when the noise is present in the environment sound, the data of the noise is processed to obtain the noise signal and the noise orientations.

In some embodiments, a maximum decibel value is obtained in the environment sound. It is detected whether the maximum decibel value is larger than a preset decibel threshold. when the maximum decibel value is detected to be larger than the preset decibel threshold, the control equipment 250 processes the noise to obtain the noise signal and the noise orientations.

In other embodiments, a maximum sound frequency is obtained in the environment sound. It is detected whether the maximum sound frequency is larger than a preset sound frequency threshold. When the maximum sound frequency is detected be larger than the preset sound frequency threshold, the control equipment 250 processes the noise to obtain the noise signal and the noise orientations.

In block S500, the noise reduction signal having the amplitude same as the noise signal, and the opposite phase to the noise signal is generated.

In block S600, the noise reduction signal is played towards the noise orientations.

The noise reduction method analyzes the facial images of the population to determine whether the one or more persons of the population are in the negative emotional expression. When the one or more persons of the population are in the negative emotional expression, the noise reduction method uses the maximum decibel value or the maximum sound frequency to determine whether the noise is present in the environment sound. When the noise is present in the environment sound, the control equipment 250 controls the sound transmitting equipment 230 to play the noise reduction signal towards the noise orientations, and the noise is reduced.

The noise reduction method can accurately determine whether the noise is present in the environment sound by analyzing the facial images of the population and the environment sound. When the noise is present in the environment sound, the noise reduction method can reduce the noise in time, and the efficiency of the noise reduction is improved.

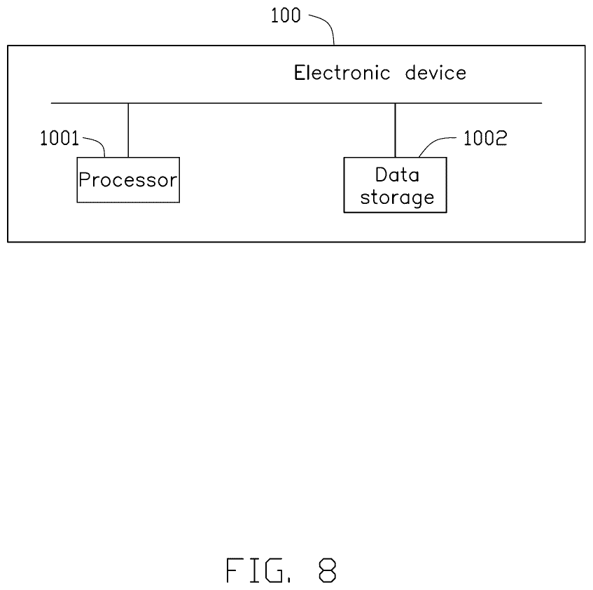

As shown in FIG. 8, one exemplary embodiment of an electronic device 1000 comprises at least one processor 1001 and a data storage 1002. The data storage 1002 stores one or more programs which can be executed by the at least one processor 1001. The data storage 1002 is used to store instructions, and the processor 1001 is used to call up instructions from the data storage 1002, so that the electronic device 1000 performs the steps of the method in the above embodiment.

In one embodiment, a non-transitory storage medium recording instructions is disclosed. When the recorded computer instructions are executed by a processor of an electronic device 1000, the electronic device 1000 can perform the method in the above embodiment.

The embodiments shown and described above are only examples. Many details known in the field are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A noise reduction method applied in a noise reduction device, the noise reduction method comprising:
obtaining environment data of a location where the noise reduction device is placed, wherein the environment data comprises environment sound and facial images of a population within a preset range of the location;
analyzing the facial images of the population to determine whether one or more persons of the population are in a negative mood;
determining whether noise is present in the environment sound in respond that the one or more persons of the population are determined to be in the negative mood using an image processing algorithm;
processing data of the noise to obtain a noise signal and noise orientations in respond that to the noise is determined to be in the environment sound;
generating a noise reduction signal having an amplitude same as the noise signal, and an opposite phase to the noise signal; and
playing the noise reduction signal towards the noise orientations.

2. The noise reduction method of claim 1, wherein analyzing the facial images of the population to determine whether the one or more persons of the population are in the negative mood, comprises:
extracting facial feature information from the facial images of each person in the population;
analyzing facial expression of the facial feature information, wherein the facial expressions comprise a negative emotional expression and a positive emotion expression; and
detecting whether the facial expression is the negative emotional expression or the positive emotion expression.

3. The noise reduction method of claim 1, wherein processing the noise to obtain the noise signal and the noise orientations when the noise is present in the environment sound comprises:
obtaining a maximum decibel value in the environment sound;
detecting whether the maximum decibel value is larger than a preset decibel threshold; and
processing the noise to obtain the noise signal and the noise orientations, in response to that the maximum decibel value is detected to be larger than the preset decibel threshold.

4. The noise reduction method of claim 1, wherein processing the noise to obtain the noise signal and the noise orientations when the noise is present in the environment sound comprises:
obtaining a maximum sound frequency in the environment sound;
detecting whether the maximum sound frequency is larger than a preset sound frequency threshold; and
processing the noise to obtain the noise signal and the noise orientation, in response to that the maximum sound frequency is detected to be larger than the preset sound frequency threshold.

5. A noise reduction device, comprising:
one or more noise reduction equipments, wherein each noise reduction equipment comprises a sound receiving equipment, a sound transmitting equipment, a sampling equipment and a control equipment, the control equipment communicates with the sound receiving equipment, the sound transmitting equipment, and the sampling equipment, the sound receiving equipment is configurated to receive environment sound of a location where the noise reduction device is placed, the sampling equipment is configured to capture facial images of a population within a preset range of the location, the control equipment is configured to analyze the facial images of the population to determine whether the one or more persons of the population are in a negative mood, the control equipment is configured to determine whether the noise is present in the environment sound in respond that the one or more persons of the population are detected in the negative mood using an image processing algorithm, the control equipment is configurated to process data of the noise to obtain a noise signal and noise orientations in respond that to the noise is determined in the environment sound, and generate a noise reduction signal having an amplitude same as the noise signal, and an opposite phase to the noise signal, the sound transmitting equipment is configured to play the noise reduction signal towards the noise orientation.

6. The noise reduction device of claim 5, wherein the noise reduction device comprises a plurality of noise reduction equipments, the plurality of noise reduction equipments communicates with each other.

7. The noise reduction device of claim 5, wherein the noise reduction device comprises one noise reduction equipment, the one noise reduction equipment comprises one control equipment, a plurality of sound receiving equipments, a plurality of sound transmitting equipments, and a plurality of sampling equipments, one of the plurality of sound receiving equipments matches with one of the plurality of sound transmitting equipments and one of the plurality of sampling equipments, the one control equipment communicates with the plurality of sound receiving equipments, the plurality of sound transmitting equipments, and the plurality of sampling equipments; the plurality of sound receiving equipments is configurated to receive the environment sound of the location where the sound receiving equipment is places, the plurality of sampling equipments is configurated to capture the facial images of the population within the preset range of the location, the plurality of sound transmitting equipments is configurated to play the noise reduction signal towards the noise orientations.

8. The noise reduction device of claim 7, wherein the plurality of sound receiving equipments is further configured to receive the environment sound emitted by one sound source; the control equipment is further configured to:
analyze the environment sound received by the plurality of sound receiving equipment to obtain sound time which the environment sound reaches each of the plurality of sound receiving equipments;
calculate distances between each of the plurality of sound transmitting equipments and the sound source and the noise orientations according to the sound time.

9. An electronic device comprising:
at least one processor; and
a data storage storing one or more programs which when executed by the at least one processor, cause the at least one processor to:
obtain environment data of a location where the noise reduction device is placed, wherein the environment data comprises environment sound and facial images of a population within a preset range of the location;
analyze the facial images of the population to determine whether one or more persons of the population are in a negative mood;
determine whether noise is present in the environment sound in respond that the one or more persons of the population are determined to be in the negative mood using an image processing algorithm;
process data of the noise to obtain a noise signal and noise orientations in respond that to the noise is determined to be in the environment sound;
generate a noise reduction signal having an amplitude same as the noise signal, and an opposite phase to the noise signal; and
play the noise reduction signal towards the noise orientations.

10. The electronic device of claim 9, wherein the at least one processor analyzing the facial images of the persons to detect whether the one or more persons of the population are in the negative mood, comprises:
extracting facial feature information from the facial images of each person in the population;
analyzing facial expression of the facial feature information, wherein the facial expressions comprise a negative emotional expression and a positive emotion expression; and
detecting whether the facial expression is the negative emotional expression or the positive emotion expression.

11. The electronic device of claim 9, wherein the at least one processor processing the noise to obtain the noise signal and the noise orientations when the noise is present in the environment sound comprises:
obtaining a maximum decibel value in the environment sound;
detecting whether the maximum decibel value is larger than a preset decibel threshold; and
processing the noise to obtain the noise signal and the noise orientations, in response to that the maximum decibel value is detected to be larger than the preset decibel threshold.

12. The electronic device of claim 9, wherein the at least one processor processing the noise to obtain the noise signal and the noise orientations when the noise is present in the environment sound comprises:
obtaining a maximum sound frequency in the environment sound;
detecting whether the maximum sound frequency is larger than a preset sound frequency threshold; and
processing the noise to obtain the noise signal and the noise orientation, in response to that the maximum sound frequency is detected to be larger than the preset sound frequency threshold.
